(19) United States
(12) Patent Application Publication
(10) Pub. No.: US 2010/0045167 A1
(43) Pub. Date: Feb. 25, 2010

(54) SURFACE LIGHT-EMITTING DEVICE AND ILLUMINATING APPARATUS AND DISPLAY APPARATUS INCLUDING THE SAME

(76) Inventors: Yasuki Kawashima, Tokyo (JP); Masafumi Hashimoto, Tokyo (JP); Junichi Yamanari, Tokyo (JP)

Correspondence Address: Mr. Jackson Chen, 6535 N. STATE HWY 161, IRVING, TX, 75039, US

(21) Appl. No.: 12/536,776

(22) Filed: Aug. 6, 2009

(30) Foreign Application Priority Data
Aug. 22, 2008 (JP) 2008-214119

(51) Int. Cl. H01J 1/62

(52) U.S. Cl. 313/498

(57) ABSTRACT

There is provided a surface light-emitting device that improves the light emission efficiency and an illuminating apparatus and a display apparatus that include the surface light-emitting element. A surface light-emitting device includes transparent substrate 1 including a central thick portion 1b protruding in the direction of light emission and a periphery thin portion 1a to be held by a holder; transparent electrode 2 laminated on transparent substrate 1 and functioning as an anode; metal electrode 6 opposite transparent electrode 2 and functioning as a cathode; and light-emitting layer 4 sandwiched between transparent electrode 2 and metal electrode 6.

This application is based upon and claims the benefit of priority from Japanese patent application No. 2008-214119, filed on Aug. 22, 2008, the disclosure of which is incorporated herein in its entirety by reference.

### BACKGROUND OF THE INVENTION

1. Field of the Invention

The present invention relates to a surface light-emitting device and an illuminating apparatus and a display apparatus using the surface light-emitting device, and to a light emitting method using the surface light-emitting device.

2. Description of the Related Art

New light emitters called EL (Electro-Luminescence) elements, which are surface light-emitting elements, are becoming widespread in addition to Light-Emitting Diodes (LEDs).

Surface light-emitting devices using EL elements have become commercialized as backlights for apparatuses such as mobile phones and audio players, and for miniature displays. As thin large-screen displays that can replace liquid-crystal and plasma displays, EL displays using EL elements have been studied and are being commercialized.

Light emitted by EL elements has a wide emission spectrum and therefore is close to natural light. In addition, light emitted by EL elements is easy on the eyes. Therefore, EL elements are suitable for application to illuminating apparatuses as well.

FIG. 1 is a cross-sectional view of an illuminating apparatus using an EL element. EL element 27 includes light-transmissive transparent electrode (anode) 22, light-emitting layer 24, and metal electrode (cathode) 26 laminated on transparent substrate 21 in this order. Preferably, hole injection/transport layer 23 fly is provided between transparent electrode 22 and light-emitting layer 24 and electron injection/transport layer 25 is provided between light-emitting layer 24 and metal electrode 26.

When a voltage is applied to transparent electrode 22 and metal electrode 26, holes from transparent electrode 22 pass through hole injection/transport layer 23 and are transported to light-emitting layer 24. Also, electrons from metal electrode 26 pass through electron injection/transport layer 25 and are transported to light-emitting layer 24. The holes and electrons transported combine in light-emitting layer 24 to generate energy, which generates light. Light emitted from light-emitting layer 24 passes through hole injection/transport layer 23, transparent electrode 22, and transparent substrate 21 and is emitted to the outside.

Unlike light sources such as fluorescent bulbs. EL element 27 can surface-emit light and is thin and lightweight. Various combinations of organic materials of light-emitting layer 24 can emit light of various colors. A flexible surface light-emitting device can be fabricated by laminating EL element 27 on flexible transparent substrate 21. Unlike fluorescent bulbs. EL element 27 does not contain harmful substances such as mercury.

However, in general, only approximately 20% of the light generated in EL element 27 is emitted to the outside. The remaining 80% of the light is not emitted to the outside and is not used. Specific percentages of the light not used are roughly as follows. Approximately 20% of the light generated is trapped in transparent substrate 21, 40 to 50% of the light is trapped in light-emitting layer 24. The remaining 10 to 20% is absorbed by metal cathode 26 and other components.

As shown in FIG. 2, light 31 trapped in transparent substrate 21 is repeatedly totally reflected in transparent substrate 21 and at least part of the light is emitted through the periphery edges of transparent substrate 21. However, the periphery of transparent substrate 21 is usually used as a portion that is held when EL element 27 is embedded as a light source in an enclosure of an apparatus such as an illuminating apparatus. In an apparatus such as an illuminating apparatus that uses EL element 27, holder 28 holds the periphery of transparent substrate 21 as shown in FIG. 1 to hold the surface light-emitting apparatus including EL element 27 in place in the enclosure. As a result, light 31 emitted through the periphery edges of transparent substrate 21 is blocked by holder 28, trapped in the enclosure and therefore cannot be used.

There is a related art in which a reflector is formed on the periphery edges of a transparent substrate to prevent light from being emitted through the periphery edges to the outside of the transparent substrate, thereby efficiently extracting light emitted from the EL element. The periphery edges of transparent substrate 21 may be angled as shown in FIG. 3 to facilitate emission of light reflected by reflector 29 to the outside. In this method, the periphery edges on which reflector 29 is formed are angled in such a manner that the area of transparent substrate 21 increases from EL element 27 side toward the outside, to cause light reflected at the periphery edges to be emitted through the main plane of transparent substrate 21, thereby improving the efficiency of extraction of the light (Japanese Patent Laid-Open No. 2004-119211). In another method, a transparent substrate including a scattering portion that scatters light and a light-transmissive opening that transmits light is used to increase scattering and transmission of light and reduce total reflection of light, thereby increasing light extraction efficiency (Japanese Patent Laid-Open No. 2005-050708).

However, with the method disclosed in Japanese Patent Laid-Open No 2004-119211, light reflected at the periphery edges of transparent substrate 21 can be repeatedly totally reflected in transparent substrate 21. When EL element 27 is used as the light source, the surface light-emitting device including EL element 27 is embedded in an enclosure with the edges of transparent substrate 21 being held by holder 28. Even though the periphery edges of transparent substrate 21 are angled, light reflected at the periphery edges of transparent substrate 21 can be blocked by holder 28. Therefore, in order that light reflected at the periphery edges of transparent substrate 21 can be emitted to the outside without being blocked by holder 28, precise adjustment of the angle of the inclination of the periphery edges is required. Furthermore, because different illuminating or display apparatuses may include holders of different sizes and shapes, the angle of inclination of the periphery edges of transparent substrate 21 needs to be varied for each apparatus, which adds to the cost.

The method disclosed in Japanese Patent Laid-Open No. 2005-050708 requires many steps of microfabrication for forming the scattering portion and the light-transmissive opening in the transparent substrate, which increases fabrication time and cost.

### SUMMARY OF THE INVENTION

An exemplary object of the present invention is to provide a surface light-emitting device and an illuminating apparatus and display apparatus including the surface light-emitting device that solve the problem of the increase in cost and complexity of a configuration for increasing light emission efficiency of a surface light-emitting device.

A surface light-emitting device according to an exemplary aspect of the invention includes a transparent substrate including a central thick portion protruding in the direction of light emission and a periphery thin portion to be held by a holder, a transparent electrode laminated on the transparent substrate and functioning as an anode, a negative electrode which is opposite the transparent electrode and functioning as a cathode, and a light-emitting layer sandwiched between the transparent electrode and the negative electrode.

The above and other objects, features and advantages of the present invention will become apparent from the following description with reference to the accompanying drawings which illustrate examples of the present invention.

### BRIEF DESCRIPTION OF THE DRAWINGS

FIG. 1 is a diagram schematically showing a cross section of a configuration of an illuminating apparatus and an example of a light path according to the related art;

FIG. 2 is an enlarged view of an end portion of the transparent substrate in FIG. 1;

FIG. 3 is an enlarged view of a cross section of an end portion of an illuminating apparatus including a plane transparent substrate with an angled edge, also illustrating an example of a path of light emitted from an electroluminescence element;

FIG. 4 is a cross-sectional view schematically showing a configuration of an exemplary illuminating apparatus according to an exemplary embodiment;

FIG. 5 is a diagram showing an example of a light path in the illuminating apparatus according to the exemplary embodiment shown in FIG. 4;

FIG. 6 is an enlarged view of an end portion of the transparent substrate in FIG. 5;

FIG. 7 is a diagram showing emission spectra of an illuminating apparatus using a plane transparent substrate according to the related art and of an illuminating apparatus using a transparent substrate whose periphery constituting a part of a step according to the present invention;

FIG. 8 is a cross-sectional view schematically showing a configuration of another exemplary illuminating apparatus using a transparent substrate including a curved edge according to an exemplary embodiment of the present invention;

FIG. 9 is a cross sectional view schematically showing a configuration of another exemplary illuminating apparatus using a transparent substrate whose periphery constituting a part of steps according to an exemplary embodiment of the present invention; and

FIG. 10 is a diagram schematically showing a configuration of another exemplary illuminating apparatus and an exemplary light path according to an exemplary embodiment of the present invention.

### DETAILED DESCRIPTION OF THE EXEMPLARY EMBODIMENTS

Exemplary embodiments of the present invention will be described below with respect to the accompanying drawings. Components having the same functions are assigned the same reference numerals in the accompanying drawings, the description of which may be omitted.

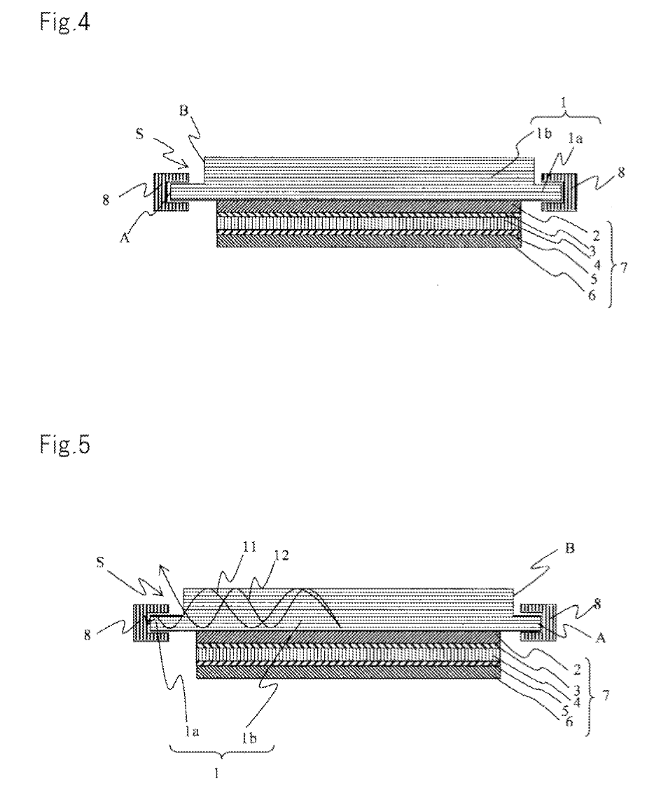

FIG. 4 schematically shows a configuration of an exemplary embodiment of an illuminating element including a surface light-emitting device according to the present invention.

Electroluminescence (EL) device 7 includes transparent electrode 2, hole injection/transport layer 3, light-emitting layer 4, electron injection/transport layer 5, and negative electrode 6 laminated on transparent substrate 1 in this order. Transparent substrate 1 is made of a light-transmissive material such as glass or a synthetic resin. Transparent electrode 2 is formed by depositing ITO (Indium Tin Oxide), which is highly light-transmissive, on transparent substrate 1 by a vacuum evaporation process. Metal electrode 6 is primarily made of aluminum. Light-emitting layer 4 is an organic electroluminescence (EL) layer made of an organic material. Hole injection/transport layer 3 and electron injection/transport layer 5 are made of a metal complex, for example. Hole injection/transport layer 3 is light-transmissive.

A principle of light emission of EL element 7 will be described. Holes generated at transparent electrode 2 are injected into hole injection/transport layer 3 and transported, while electrons generated at metal electrode 6 are injected in electron injection/transport layer 5 and are transported. The holes transported from hole injection/transport layer 3 and the electrons transported from electron injection/transport layer 5 combine in light-emitting layer 4 to generate energy, which generates light.

In an exemplary surface light-emitting device according to the exemplary embodiment of the present invention shown in FIG. 5, transparent substrate 1 includes thick portion 1b protruding in the direction of light emission and the remaining thin portion 1a. Thick portion 1b is positioned in the center of transparent substrate 1 and thin portion 1a is positioned at the periphery of transparent substrate 1. Step S is formed at the boundary between thick portion 1b and thin portion 1a. FIG. 5 shows an example of how light generated by light-emitting layer 4 is emitted through transparent substrate 1 when EL element 7 actually emits light in the surface light-emitting device. The light path shown in this example illustrates a path of light totally reflected in transparent substrate 1. For clarity, only light coming through central region of the lower surface of transparent substrate 1 is shown.

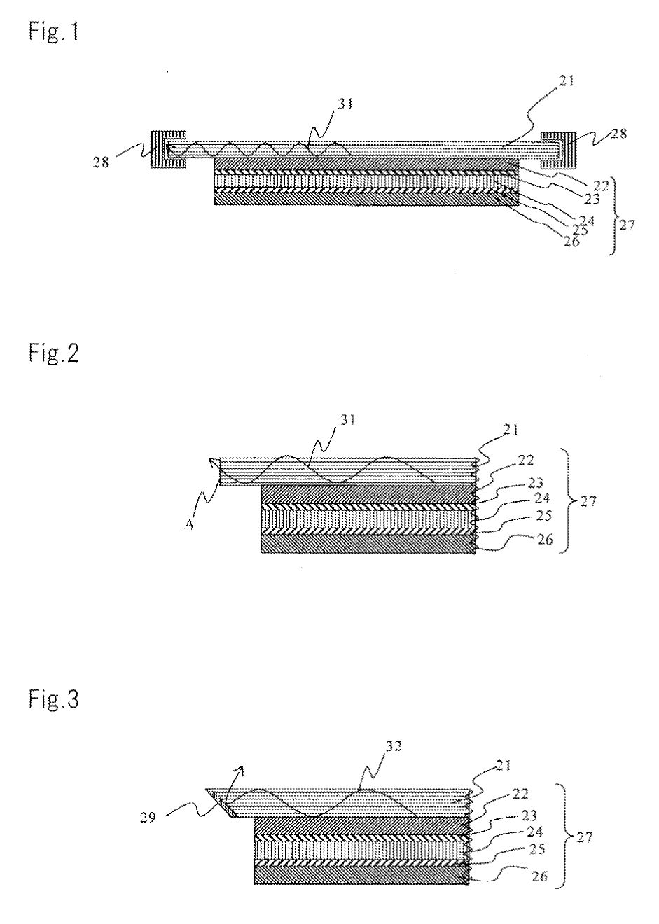

Part of light (not shown) transmitted from light-emitting layer 4 to the central region of the lower surface of transparent substrate 1 through hole injection/transport layer 3 and transparent electrode 2 directly passes through thick portion 1b of transparent substrate 1 and is emitted to the outside. However, other part of light 11 is repeatedly totally reflected in transparent substrate 1 and, as in the example in FIG. 1, is emitted through the outermost edge of transparent substrate 1, that is, periphery edge A of thin portion 1a and travels toward holder 8. However, yet other light 12 transmitted to the lower surface of transparent substrate 1 is repeatedly totally reflected and travels in transparent substrate 1 and then is emitted to the outside through step S of transparent substrate 1, in particular, periphery edge B of thick portion 1b that is not covered by holder 8. Light 12 emitted to outside through step S is then not blocked by holder 8 and therefore contributes to an increase in the amount of light emitted from the surface light-emitting device including EL element 7.

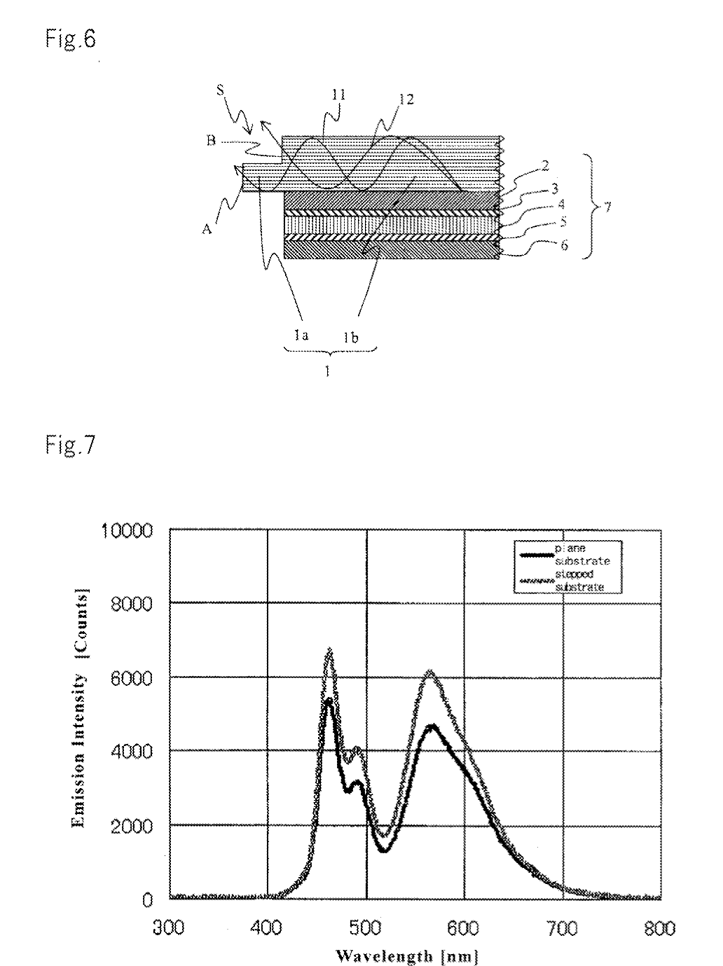

Comparing FIG. 6 with FIGS. 1 and 2, features of the exemplary embodiment will be further described.

FIG. 6 is an enlarged view of an end portion of the transparent substrate of the exemplary embodiment shown in FIG. 5; FIG. 1 shows an illuminating apparatus according to the related art; and FIG. 2 is an enlarged view of an end portion of the plane transparent substrate of the illuminating apparatus.

As has been described above, in the illuminating apparatus of the related art, part of generated light 31 is repeatedly totally reflected in plane transparent substrate 21 and is emitted through periphery edge A of plane transparent substrate 21 to the outside. However, emitted light 31 is blocked by holder 28 of the illuminating apparatus and cannot be used.

In the case of the present invention, at the periphery of transparent substrate 1 in addition to periphery edge A of thin portion 1a held by holder 8 of the illuminating apparatus, periphery edge B that is not held by holder 8 is provided nearer to the center of transparent substrate 1 than periphery edge A. Generated light 11 is emitted through edge A and is blocked by holder 8 of the illuminating apparatus as in the related art. However, other light 12 is emitted to the outside through periphery edge B of thick portion 1b. Light 34 emitted through periphery edge B of thick portion 1b is not blocked by holder 8 of the illuminating apparatus.

In this way, according to the present invention, step S is formed at the boundary between thick portion 1b and thin portion 1a to provide one or more edges in a position that is not held by holder 8 of the illuminating apparatus, in addition to the edge held by holder 8, thereby the amount of light emitted from the surface light-emitting device can be increased. This is because light can be emitted to the outside through not only the main plane of transparent substrate 1 but also periphery edge B of thick portion 1b that is newly provided in the position not covered by holder 8.

The inventors actually measured the difference between the amount of light (light flux amount) emitted to the outside from an EL illuminating apparatus using plane transparent substrate 21 as in the related art and the amount of light emitted to the outside from an EL illuminating apparatus in which transparent substrate 1 includes thick portion 1b protruding in the direction of light emission, thin portion 1a positioned on the outer side of thick portion 1b and designed to be held by a holder, and step S formed by thick portion 1b and thin portion 1a. FIG. 7 shows the emission spectra of the light. SourceMeter Model 2425 from Keithley Instruments Inc. was used as the power supply. The measurement was carried out with a current of 20 mA and a voltage of 3.5V. The light flux amounts were measured with PMA-11 from Hamamatsu Photonics K.K.

It can be seen from FIG. 7 that the emission intensity of the EL illuminating apparatus using transparent substrate 1 that includes thick portion 1b, thin portion 1a, and step S formed by thick portion 1b and thin portion 1a is greater than or equal to that of the EL illuminating apparatus using plane transparent substrate 21 of the related art at all wavelengths. The light flux amount of the EL illuminating apparatus using transparent substrate 1 including thick portion 1b, thin portion 1a, and step S formed by thick portion 1b and thin portion 1a was 28% greater than that of the EL illuminating apparatus using plane transparent substrate 21.

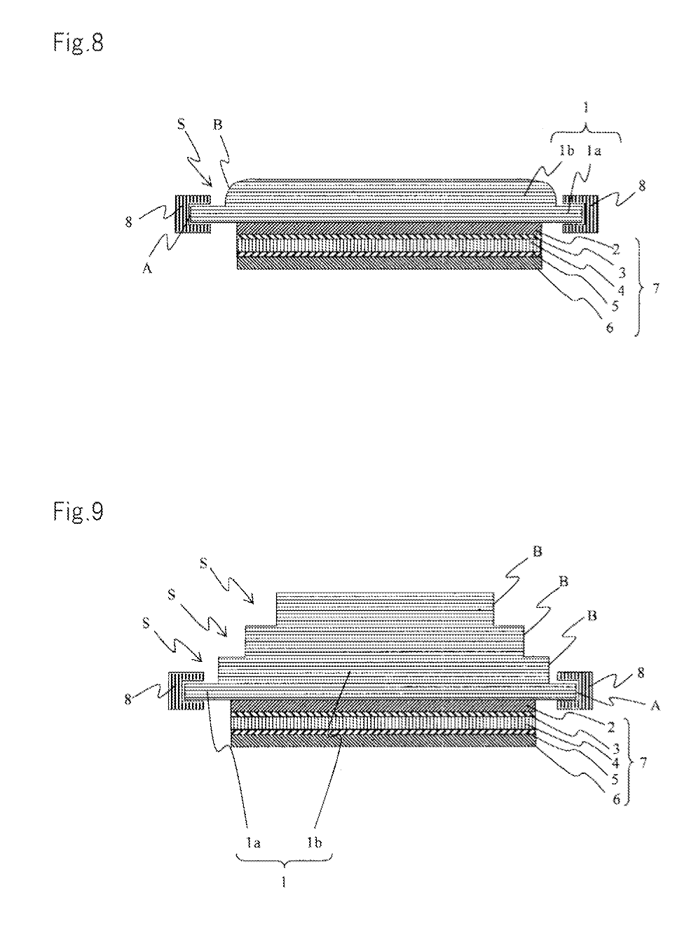

The orientation of light emitted from the periphery edge of thick portion 1b of transparent substrate 1 can be controlled by curving or tapering the edge of transparent substrate 1 as shown in FIG. 8.

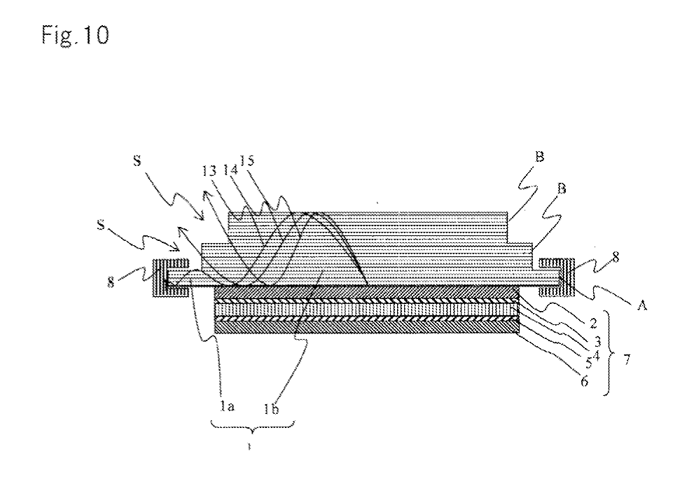

Thick portion 1b and thin portion 1a of transparent substance 1 do not necessarily need to be formed from a single plane plate. Thick portion 1b and thin portion 1a may be formed by laminating plane substrates of different sizes on one another. The surface of transparent substrate 1 may be given a finish for scattering light in order to reduce the amount of total reflection of light in transparent substrate 1. Transparent substrate 1 may have a stair-like shape including steps S as shown in FIGS. 9 and 10.

In the alternative exemplary surface light-emitting device according to alternative exemplary embodiment of the present invention shown in FIG. 10, transparent substrate 1 has a stair-like shape including two steps S. In this configuration, light 13 transmitted through the central region of the lower surface of transparent substrate 1 is repeatedly totally reflected in transparent substrate 1, emitted through periphery edge A of thin portion 1a, and then blocked by holder 8 of the illuminating apparatus. However, other light beams 14, 15 similarly transmitted are repeatedly totally reflected and travel in transparent substrate 1 and then are emitted to the outside through edges B of thick portion 1b of transparent substrate 1. These light beams 14, 15 contribute to the increase in the amount of light emitted from the EL illuminating apparatus because they are not blocked by holder 8 after being emitted to the outside.

The exemplary embodiments have been described with respect to an illuminating apparatus that holds a surface light-emitting device including an EL element in an enclosure by way of example. The illuminating apparatus may be used as a backlight of an electronic apparatus or used as a lamp for indoors or outdoors. Although not shown, a display apparatus including an enclosure including a holder similar to that described above can also be fabricated by using a surface light-emitting device according to the present invention.

An exemplary advantage according to the invention is that the light emission efficiency of the surface light-emitting device can be improved. This is because transparent substrate 1 includes thick portion 1b protruding in the direction of light emission and thin portion 1a positioned on the outer side of thick portion 1b and designed to be held by a holder, thereby light from light-emitting layer 4 can be emitted to the outside through not only the main plane of transparent substrate 1 but also through periphery edge B of thick portion 1b

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A surface light-emitting device comprising:
a transparent substrate including a central thick portion protruding in a direction of light emission and a periphery thin portion to be held by a holder;
a transparent electrode laminated on the transparent substrate and functioning as an anode;
a negative electrode opposite the transparent electrode and functioning as a cathode; and
a light-emitting layer sandwiched between the transparent electrode and the negative electrode.

2. The surface light-emitting device according to claim 1, wherein a step is formed at a boundary between the thick portion and the thin portion of the transparent substrate.

3. The surface light-emitting device according to claim 2, wherein the step of the transparent substrate includes an edge angled at 90 degrees or less.

4. The surface light-emitting device according to claim 2, wherein the step of the transparent substrate has a curvature.

5. The surface light-emitting device according to claim 2, wherein a stair-like shape including the steps is formed at the boundary between the thick portion and the thin portion of the transparent substrate.

6. The surface light-emitting device according to claim 2, wherein the step at the boundary between the thick portion and the thin portion is formed by laminating transparent substrates of different sizes.

7. The surface light-emitting device according to claim 6, wherein a light-scattering finish is formed on a surface of the transparent substrate on which layers are laminated.

8. The surface light-emitting device according to claim 1, wherein the light-emitting layer is an electroluminescence layer.

9. An illuminating apparatus comprising the surface light-emitting device according to claim 1 and a holder holding the thin portion of the transparent substrate to support the transparent substrate.

10. A display apparatus comprising the surface light-emitting device according to claim 1 and a holder holding the thin portion of the transparent substrate to support the transparent substrate.

11. A light emitting method comprising
causing a hole from a transparent electrode which is laminated on a transparent substrate and which functions as an anode, and an electron from a negative electrode which is opposite the transparent electrode and which functions as a cathode, to combine in a light-emitting layer sandwiched between the transparent electrode and the negative electrode to generate light by a binding energy caused by combining the hole and the electron;
causing light from the light-emitting layer to be emitted to an outside through the transparent electrode and a thick portion of the transparent substrate; and
causing light reflected in the transparent substrate to be emitted to the outside through a step formed at a boundary between the thick portion and a thin portion at a periphery of the transparent substrate.

12. The light emitting method according to claim 11, wherein at least part of light reflected in the transparent substrate is emitted through a periphery edge of the thick portion to the outside, the periphery edge constituting a part of the step.
